(19) United States
(12) Patent Application Publication
(10) Pub. No.: US 2025/0088952 A1
(43) Pub. Date: Mar. 13, 2025

(54) METHOD AND SYSTEM FOR CAPABILITY AWARENESS IN STEERING OF ROAMING

(71) Applicant: Cisco Technology, Inc., San Jose, CA (US)

(72) Inventors: Vimal Srivastava, Bangalore (IN); Sri Gundavelli, San Jose, CA (US); Ravi Kiran Guntupalli, Cumming, GA (US)

(21) Appl. No.: 18/463,057

(22) Filed: Sep. 7, 2023

(51) Int. Cl. H04W 48/18; H04W 8/22; H04W 48/16; H04W 60/00

(52) U.S. Cl. CPC H04W 48/18; H04W 8/22; H04W 48/16; H04W 60/005

(57) ABSTRACT

Systems and methods are provide to bring network capability awareness to steering of roaming (SoR). A home network includes a capabilities list of visited networks and their associated with the network capabilities. For SoR, he user equipment (UE) maintains a roaming partners list (RPL). The RPL provides a list of visited networks arranged in order of priority/preference (e.g., the first visited network in the RPL has first priority). The first visited network receives a registration request from the UE and relays a corresponding authentication request to the home network. The visited network in the RPL can be reordered when the UE requires a network capability not supported by the first visited network in the RPL, as indicated by the capabilities list. Depending on the implementation, the UE or the home network can make this decision to reorder the RPL.

### TECHNICAL FIELD

The present disclosure relates to wireless communication systems, and in particular to improved steering of roaming (SoR) that incorporates awareness of network capabilities when selecting a preferred roaming partner.

### BACKGROUND

3GPP supports steering of roaming (SoR) in which a roaming partners list (RPL) is used to steer user equipment (UE) to a preferred visited public land mobile network (PLMN). For example, based on the RPL, a home (PLMN) can steer its roaming subscribers to preferred partner networks by means of updating the operator-controlled PLMN selector list via signaling (SoR). Using this an operator can direct a UE to latch on to a preferred roaming partner via SoR based on roaming agreement or cost, for example.

SoR has not previously incorporated awareness of network capabilities when selecting a preferred roaming partner. Thus, there is a need for improved SoR that does incorporate awareness of network capabilities when selecting a preferred roaming partner.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a schematic diagram of an example of an environment including home and visited wireless communication networks, in accordance with certain embodiments.

FIG. 2 illustrates a block diagram of an example of a wireless communication network, in accordance with certain embodiments.

FIG. 3 illustrates a call flow for steering of roaming without network capability awareness, in accordance with certain embodiments.

FIG. 4 illustrates a first call flow for steering of roaming with network capability awareness, in accordance with certain embodiments.

FIG. 5 illustrates a second call flow for steering of roaming with network capability awareness, in accordance with certain embodiments.

FIG. 6 illustrates a flow diagram for a method of steering of roaming with network capability awareness, in accordance with certain embodiments.

FIG. 7 illustrates a block diagram of an example of a computing device, in accordance with certain embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### OVERVIEW

In one aspect, a method is provided for bringing network capability awareness to steering of roaming. The method includes providing, in a home network, a first list of visited networks, wherein the first list includes visited networks, and the first list associates the visited networks with corresponding network capabilities of the respective visited networks. The method includes providing, in user equipment (UE), a roaming partners list (RPL) that includes a plurality of visited networks arranged in order of priority with a first visited network having priority over other visited networks in the plurality of visited networks. The method includes receiving, at the first visited network, a registration request from the UE, wherein registration request is a request to register the UE with the first visited network. The method includes determining whether to register the UE with the first visited network based on whether the first list indicates that the first visited network is associated with a first network capability, wherein the first network capability is a network capability that is requested by the UE.

In another aspect, the method may also include sending, from the UE to the first visited network, the registration request that includes an indication that the first network capability is being requested by the UE; receiving, at the home network, an authentication request from the first visited network, wherein the authentication request indicates that the first network capability is being requested; comparing, at the home network, the first network capability to the network capabilities in the first list; and determining, based on the comparison, whether the first visited network supports the first network capability, and generating thereby a determination result.

In another aspect, determining whether the first visited network supports the first network capability is based on comparing the first network capability to the network capabilities in the first list to determine whether the first network capability matches one or more network capabilities in the first list that are associated with the visited network.

In another aspect, when the determination result is that the first visited network supports the first network capability, the method may also include sending, to the first visited network, an acceptance of the registration request; and registering the UE with the first visited network.

In another aspect, when the determination result is that the first visited network does not support the first network capability, the method may also include sending, to the first visited network, an instruction for the UE to reorder the plurality of visited network in the RPL such that one or more other visited network that are determined by the comparison to the first list to support the first network capability are prioritized ahead of the first visited network; and registering the UE with a second visited network that is in a highest priority in the reordered RPL.

In another aspect, the method may also include receiving, from the first visited network to the UE, network-capability information indicating which of the visited networks in the first list are associated with which network capabilities; determining that the UE wants a first network capability; and comparing, at the UE, the first network capability to the received network-capability information to determine whether the first visited network supports the first network capability, and generating thereby a determination result.

In another aspect, when the determination result is that the first visited network supports the first network capability, the method may also include registering the UE with the first visited network.

In another aspect, when the determination result is that the first visited network does not support the first network capability, the method may also include reordering the RPL such that an other visited network that supports the first network capability is moved to a top of the RPL and is thereby prioritized ahead of the first visited network; and registering the UE with the other visited network.

In another aspect, the first network capability is selected from the group consisting of a time sensitive network (TSN) feature, an access traffic steering, switching and splitting (ATSSS) feature, an ATSSS lower layer (ATSSS-LL) feature, a voice over WiFi (VoWiFi) feature, an ethernet protocol data unit (PDU) feature, a multi-path transmission control protocol (MPTCP), an MPTCP Proxy feature, a fine timing measurement (FTM) feature, and a non-regulatory location services feature.

In another aspect, the method may also include registering the UE with the first visited network; after registering that the UE with the first visited network, signaling, at the UE, that based on the first list the first visited network does not support the first network capability; reordering the RPL such that an other visited network that supports the first network capability is moved to a top of the RPL and is thereby prioritized ahead of the first visited network; deregistering the UE with the first visited network; and registering the UE with the other visited network

In one aspect, a computing apparatus includes a processor. The computing apparatus also includes a memory storing instructions that, when executed by the processor, configure the apparatus to perform the respective steps of any one of the aspects of the above recited methods.

In one aspect, a computing apparatus includes a processor. The computing apparatus also includes a memory storing instructions that, when executed by the processor, configure the apparatus to provide, in a home network, a first list of visited networks, wherein the first list includes visited networks, and the first list associates the visited networks with corresponding network capabilities of the respective visited networks; provide, in user equipment (UE), a roaming partners list (RPL) that includes a plurality of visited networks arranged in order of priority with a first visited network having priority over other visited networks in the plurality of visited networks; receive, at the first visited network, a registration request from the UE, wherein registration request is a request to register the UE with the first visited network; and determine whether to register the UE with the first visited network based on whether the first list indicates that the first visited network is associated with a first network capability, wherein the first network capability is a network capability that is requested by the UE.

In another aspect, when executed by the processor, instructions stored in the memory cause the processor to send, from the UE to the first visited network, the registration request that includes an indication that the first network capability is being requested by the UE; receive, at the home network, an authentication request from the first visited network, wherein the authentication request indicates that the first network capability is being requested; compare, at the home network, the first network capability to the network capabilities in the first list; and determine, based on the comparison, whether the first visited network supports the first network capability, and generating thereby a determination result.

In another aspect, the determining whether the first visited network supports the first network capability is based on comparing the first network capability to the network capabilities in the first list to determine whether the first network capability matches one or more network capabilities in the first list that are associated with the visited network.

In another aspect, when executed by the processor, instructions stored in the memory cause the processor to conditionally send, to the first visited network, an acceptance of the registration request, based on a condition that the determination result is the first visited network supports the first network capability; and register the UE with the first visited network.

In another aspect, when executed by the processor, instructions stored in the memory cause the processor to conditionally send, to the first visited network, an instruction based on a condition that the determination result is the first visited network supports the first network capability, wherein the instruction is for the UE to reorder the plurality of visited network in the RPL such that one or more other visited network that are determined by the comparison to the first list to support the first network capability are prioritized ahead of the first visited network; and register the UE with a second visited network that is in a highest priority in the reordered RPL.

In another aspect, when executed by the processor, instructions stored in the memory cause the processor to receive, from the first visited network to the UE, network-capability information indicating which of the visited networks in the first list are associated with which network capabilities; determine that the UE wants a first network capability; and compare, at the UE, the first network capability to the received network-capability information to determine whether the first visited network supports the first network capability, and generating thereby a determination result.

In another aspect, when executed by the processor, instructions stored in the memory cause the processor to conditionally send, to the first visited network, an acceptance of the registration request, based on a condition that the determination result is the first visited network supports the first network capability; and register the UE with the first visited network.

In another aspect, when executed by the processor, instructions stored in the memory cause the processor to conditionally reorder the RPL, based on a condition that the determination result is that the first visited network does not support the first network capability, wherein the RPL is reordered such that an other visited network that supports the first network capability is moved to a top of the RPL and is thereby prioritized ahead of the first visited network; and registering the UE with the other visited network.

In another aspect, the first network capability is selected from the group consisting of a time sensitive network (TSN) feature, an access traffic steering, switching and splitting (ATSSS) feature, an ATSSS lower layer (ATSSS-LL) feature, a voice over WiFi (VoWiFi) feature, an ethernet protocol data unit (PDU) feature, a multi-path transmission control protocol (MPTCP), an MPTCP Proxy feature, a fine timing measurement (FTM) feature, and a non-regulatory location services feature.

In another aspect, when executed by the processor, instructions stored in the memory cause the processor to register the UE with the first visited network; after registering the UE with the first visited network, signal, based on the first list, that the first visited network does not support the first network capability, wherein the signaling occurs at the UE; reorder the RPL such that an other visited network that supports the first network capability is moved to a top of the RPL and is thereby prioritized ahead of the first visited network; deregister the UE with the first visited network; and register the UE with the other visited net work.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for improved steering of roaming (SoR) that incorporates awareness of network capabilities when selecting a preferred roaming partner.

To illustrate the need in the art for SoR with network capability awareness, consider a scenario in which user equipment (UE) has determined to enable a network capability. In this scenario, the network capability is illustrated by the non-limiting example of an Access Traffic Steering, Switching and Splitting (ATSSS) feature to divert some traffic over Non-3GPP access. To enable this ATSSS feature, the UE depends on awareness of whether the serving network has support for the ATSSS feature. It is possible that a given serving network supports both 3GPP access and Non-3GPP access but does not support ATSSS because support for ATSSS depends on many enhancements in the core network (e.g., ATSSS-LL, MPTCP, MPTCP Proxy, etc.). In the current 3GPP SoR, however, such information is not provided as part of RPL in the SoR. Consequently, there is no way for UE to selectively latch on to a serving network depending on whether certain specific network capabilities are supported.

SoR with network capability awareness contrasts with access technology and Slice, which is part of the SoR information that can be used by a UE to select V-PLMN based on the supported slice. For example, 3GPP SoR does not consider the serving network provides certain network capabilities when generating the roaming partners list (RPL). But if the capabilities of the serving network were considered, a UE can latch on to the serving network having those certain network capabilities preferred by UE.

Although the UE is aware of data network name (DNN) and Slice, this awareness is insufficient to use the full potential of the UE and network. Network capabilities (e.g. ATSSS, TSN, etc.) are not specific to a Slice or DNN, and therefore more information is required at the UE to select a network that supports desired capabilities while roaming. Part of the registration acceptance by the access and mobility management function (AMF) provides a list of “network feature support” (e.g., ATSSS, N26 Interface, etc.) to the UE. However, the systems and methods disclosed herein go beyond this by solving the problem of network selection before the registration procedure. For example, the systems and methods disclosed herein provide reordering of the visited networks in the RPL based on which of the visited network provide the network capabilities that are desired/required by the UE. Further, the reordering of the RPL can be based on a list of visited networks and the associated network capabilities for each of the respective visited networks. Further, in certain non-limiting examples, this list of associated network capabilities, which is maintained in and updated by the home network, can be shared with the UE.

As discussed above, the example of the desired network capabilities being the ATSSS feature is a non-limiting example, and there are many other desired network capabilities that can be included under the umbrella of network-capability-aware SoR. That is, there are many such network capabilities supported by 5GC, including, e.g., ATSSS, non-regulatory Location services or TSN that may/may not be supported by the serving network. Therefore bring network capabilities level cognizance in the RPL is beneficial to enable UE to select the most appropriate visited network which serves the needs of the UE.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

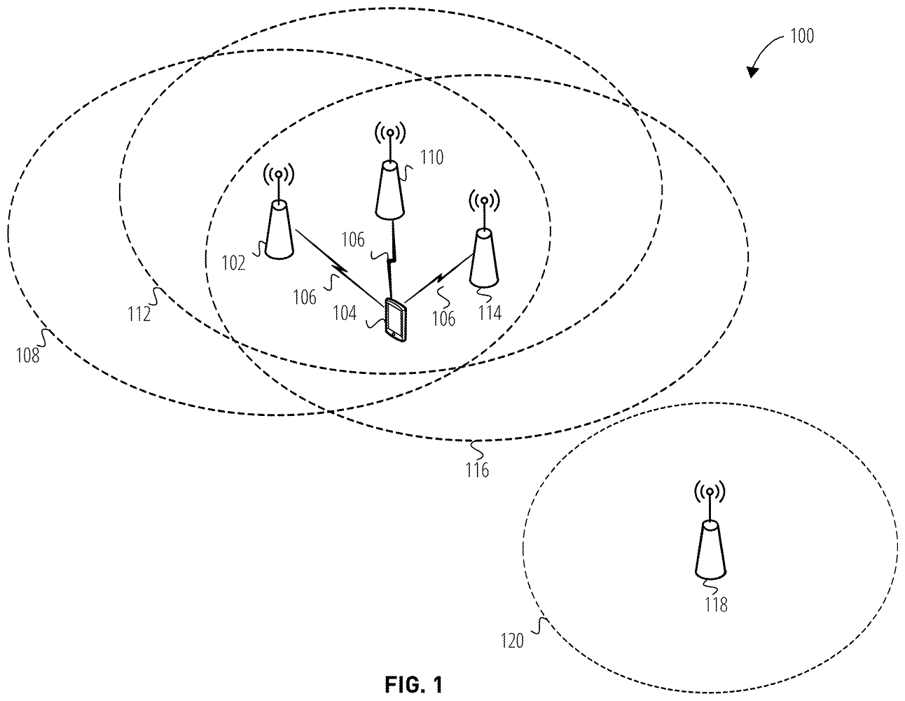

FIG. 1 shows a block diagram of an example a roaming scenario according to some aspects of the present disclosure. The roaming scenario 100 can include a radio access network (RAN) 118 for a home public land mobile network (HPLMN) and RANs for several visited public land mobile network (VPLMN), which are illustrated by RAN 102 for a VLPMN-A, RAN 110 for VLPMN-B, and RAN 114 for VLPMN-C. In FIG. 1, the user equipment (UE) 104 is out of the coverage area 120 of RAN 102 and the HPLMN, but the UE 104 is within the coverage area 108 of the VPLMN-A. Additionally, the UE 104 is within the coverage area 108 of the VPLMN-B, and the UE 104 is within the coverage area 116 of the VPLMN-C. Respective communication links 106 can connect the UE 104 to each of the RANs 102, 110, and 114.

In the roaming scenario 100, the UE 104 is a subscriber to the HPLMN, and, when the UE 104 leaves the coverage area 120 of the HPLMN, roaming allows the UE 104 to continue to send and receive messages with by using one of the VPLMNs. The UE 104

In wireless telecommunications, the term “roaming” can refer to a situation in which mobile devices (e.g., UE 104) are being used outside the range of its native network by connecting to another available cell network. Further, roaming can refer to a functionality in which a cellular customer uses a visited network to automatically make and receive voice calls, send and receive data, or access other services, including home data services, when travelling outside the geographical coverage area of the home network. For example, should a subscriber travel beyond their cell phone company's transmitter range, their cell phone would automatically hop onto another phone company's service, if available. The term “home network” refers to the network the subscriber is registered with, and “visited network” refers to the network a subscriber roams temporarily and is outside the bounds of the home network. The legal roaming business aspects negotiated between the roaming partners for billing of the services obtained are usually stipulated in roaming agreements

3GPP supports steering of roaming (SoR) in which a Home PLMNs uses a roaming partners list (RPL) to steer their roaming subscribers to preferred partner networks by means of updating the Operator Controlled PLMN Selector list via signaling. Using the RPL, an operator can direct a UE 104 to latch on to preferred roaming partner via SoR based on roaming agreement/costs.

In FIG. 1, the UE 104 can latch onto one of the roaming partners VPLMN-A, VPLMN-B, and VPLMN-C. The RPL can be used to ensure that the UE 104 latches onto the visited network with the most favorable roaming agreement/costs. But sometimes the UE 104 can require services/features that are only available from some of the visited networks. The systems and methods described herein overcome this limitation by augmenting the roaming steering process to provide network capability awareness.

Consider an example in which, the UE 104 wants to enable an Access Traffic Steering, Switching and Splitting (ATSSS) feature while roaming. The ATSSS feature allows the diversion of some traffic over Non-3GPP access. Not all visited networks will support ATSSS. Thus, to ensure that the UE 104 latches on to a visited network that supports the desired network capability (i.e., ATSSS in this case), the UE 104 would need to be aware of which visited networks support the desired network capability. For example, it is possible that a given visited network supports both 3GPP/Non-3GPP access but does not support ATSSS, which depends on several enhancements in the core network (e.g., ATSSS-LL, MPTCP, MPTCP Proxy, etc.).

Currently, 3GPP lacks such information as part of RPL in the SoR and there is no way for UE 104 to selectively latch on the visited network where certain specific network capabilities are supported. Although access technology and slice is part of the SoR information which can be used by UE 104 to select a particular visited network based on the supported slice, in the RPL generated by SoR that is provided in 3GPP, the capabilities provided by the visited network are not accounted for, such that a UE 104. If, however, the capabilities provided by the visited network were accounted for (as is the case for certain systems and methods disclosed herein), then the RPL generated by SoR would enable the UE 104 to latch on to the preferred visited network that has the desired network capabilities. The above example in which the desired network capability is ATSSS is non-limiting, and the desired network capability can be any existing network capability or any network capability that is developed in the future. For example, there are many such capabilities supported by 5GC (ATSSS, non-regulatory Location services or TSN) which may/may not be supported by a visited network. Therefore, bringing network capabilities level cognizance in the RPL is beneficial to enable UEs to select the most appropriate visited network that serves the UEs needs.

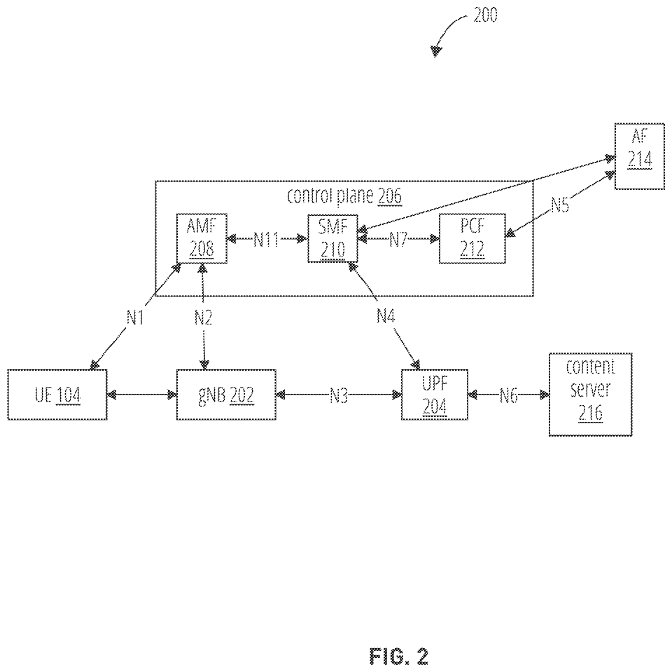

FIG. 2 illustrates a wireless network 200, which can be either a home network of a visited network. The wireless network 200 includes a user equipment (UE) 104, a next generation NodeB (gNB) 202, a user plane function (UPF) 204, a control plane 206 (which includes an access and mobility management function (AMF) 208, a session management function (SMF) 210, a policy control function (PCF) 212), an application function (AF) 214, and a content server 216.

According to certain non-limiting examples, embodiments, and implementations, the wireless network 200 can be a 5G wireless network in which embodiments presented herein may be imple-mented. The wireless network 200 may include a number of network nodes and/or entities, such as a user equipment (UE) device 104 (referred to simply as “UE” or “the UE”), e.g., a mobile telephone. The wireless network 200 may be, for example, an enterprise private Third Generation Partnership project (3GPP) based network, such as a private Fifth Generation (5G) network for “private 5G.” Such enterprise deployments may have mis-sion-critical devices, Internet of Things (IoT) devices, and/or robotics devices, where application-specific Quality of Service (QOS) treatment, low latency, and reliability are key considerations.

It will be appreciated that the wireless network 200 typically includes multiple UE devices; however, one UE is depicted for simplicity. The UE 104 may be any suitable type of device, such as a cellular telephone, a smartphone, a tablet device, an IoT device, a Machine-to-Machine (M2M) device, a robotics device, and a sensor, etc. UE 104 may obtain access to the private 5G network via one or more base stations, such as a gNB 202.

In the non-limiting example in FIG. 2, the wireless network 200 is illustrated with the gNB 202 being a next generation NodeB (gNB), but it is understood that, instead of using a gNB as the radio access network (RAN), the wireless network 200 may be implemented using, as an RAN, one or more of an evolved universal mobile telecommunications system (UMTS) terrestrial radio gNB (E-UTRAN), a radio area network, and/or a next generation radio area network (NG-RAN) (each more generally referred to as a “RAN”). The gNB 202 may include one or more eNodeB (eNB) entities and/or one or more next generation NodeB (gNB) devices. The eNB and gNB entities (more generally referred to as a “gNB”) may communicate with one another via one or more X2 (referred to as “Xn” in 5G) interfaces.

In the data plane, the wireless network 200 also includes a UPF 204 and a content server 216. As discussed in more detail below, the data plane supports various methods for sending protocol data units (PDUs) from the content server 216 to the UE 104 to achieve ultra-reliability and low latency communication (URLLC). Some of these methods support redundant flows of traffic over portions of the transmission path m the content server 216 to the UE 104 (e.g., copies of the same PDUs are sent along various legs of the transmission path). Thus, the UE 104 or gNB 202 may receive duplicate flows of packets/PDUs, such that when packets are dropped along a given leg of the transmission path due, e.g., to network problems, the UE 104 continues to receive at least one copy of the dropped packets/PDUs, to achieve URLLC.

In addition to the data plane of the wireless network 200 over which flows of traffic are conveyed between the UE 104 to the content server 216, the wireless network 200 also includes a control plane 206 to manage/control the data plane. The wireless network 200 may include one or more local area networks (LANs) and one or more wide area networks (WANs), such as the Internet.

Control planes of a control plane 206 may be utilized in the wireless network 200 for access and mobility management, session management, and/or policy management and control for the UE 104. In particular, the control plane 206 may include an Access and Mobility Management Function (AMF) 210 and a Session Manage-ment Function (SMF) 210. The AMF 208 and SMF 210 may be implemented as separate functions or components, or alter-natively provided together as an integrated functionality (in whole or in part) and/or co-located at the same node or component. A protocol data unit (PDU) session at UPF 204 may be managed by SMF 210 over an N4 interface using a Packet Forwarding Control Protocol (PFCP), for example. In some imple-mentations, control plane 206 is provided locally in the wireless network 200. In other implementations, control plane 206 is provided as part of a cloud infrastruc-ture. In some implementations, the private 5G network may be configured without use of a Policy and Control Function (PCF) 214.

UE 104 may communicate with access and mobility management function (AMF) 208 via the gNB 202. The AMF 208 may communicate control signaling (e.g., non-access stratum (NAS) signaling) with UE 104 using an N1 interface. The AMF 208 may commu-nicate control signaling with the gNB using an N2 interface. The AMF 208 may facilitate communication by other network functions with UE 104 and/or the gNB 202. For example, other network functions may subscribe to notifications regarding mobility events relating to UE 104. The AMF 208 may support the termination of non-access stratum (NAS) signaling, NAS ciphering and integrity protection, registration management, connection management, and/or mobility management. The AMF 208 may support access, authentication, and authorization (AAA) and/or security context management.

The AMF 208 may communicate control signaling with a session management function (SMF) 112 using an N11 interface. The SMF 210 may support session establish-ment, modification, and/or release. The SMF 210 may allocate and manage the allocation of an internet protocol (IP) address to UE 104. The SMF 210 may support dynamic host configuration protocol (DHCP) functions. The SMF 210 may support the termination of NAS signaling related to session management. The SMF 210 may support traffic steering configuration for one or more user plane functions (UPFs) 206. When multiple AMFs are present, they may communicate with each other over one or more N14 interfaces.

The UPF 204 may communicate control signaling with the SMF 210 using an N4 interface. If multiple UPF entities are present, they may communicate control signaling with each other using one or more N9 interfaces. The one or more UPF 204 may commu-nicate data signaling with the gNB 202 using an N3 interface. The UPF 204 may support packet routing and forwarding, packet inspection, and han-dling of quality of service (QOS). The UPF 204 may act as an external protocol data unit (PDU) session point of interconnect to a content server 216, such as the Internet. The UPF 204 may communicate data signaling with the content server 216 using an N6 interface. The UPF 204 may serve as an anchor point for mobility within and between radio access technologies (RATs).

A policy control function (PCF) 214 may communicate control signaling with the SMF 210 using an N7 interface. The PCF 212 may communicate control signaling with the AMF 208 using an N15 interface. The PCF 212 may provide policy rules to other control plane entities. The PCF 212 may provide access to subscription information for policy decisions in a unified data repository, for example.

An application function (AF) 214 may communi-cate control signaling with the PCF 212 using an N5 interface. The AF 214 may support application influence on traffic routing. The AF 214 may interact with the PCF 212 to provide policy control. In the ensuing description, control signaling, data signal, and NAS signaling may be referred to more generally as “signaling.”

Now, the above concepts are illustrated by, but not limited to, the system architecture for the 5G system (5GS). For example, the Fifth Generation of Mobile Telephony, or 5G, or 5GS, is the system defined by 3GPP from Release 15. Schematically, the 5G system uses the same elements as the previous generations: user equipment (UE), which includes a mobile station and a Universal Subscriber Identity Module (USIM), a radio access network (NG-RAN), and the core network (5GC). The main entity of the NG-RAN is the gNB. The gNB may be split into a gNB-central unit (gNB-CU) and one or more gNB-distributed unit(s) (gNB-DU).

The 5GC includes the User Plane Function (UPF), which handles the user data, and, in the signaling plane, 5GC includes the access and mobility management Function (AMF) that accesses the UE and the (R) AN. Further, the 5GC architecture relies on a “Service-Based Architecture” (SBA) framework, where the architecture elements are defined in terms of Network Functions (NFs), rather than by traditional “Network Entities. Via interfaces of a common framework, any given NF offers its services to all the other authorized NFs and/or to any consumers that are permitted to make use of these provided services. Such an SBA approach offers modularity and reusability.

The services offered by an NF in the network can be selected, for instance, by a UE for core access and mobility manage-ment. The UE can establish transport sessions for data transfer and maintains continuous communication with the network for several control and management tasks. The NFs can include, e.g., the Access and Mobility Function (AMF), the Session Management Function (SMF), the User Plane Function (UPF), an Authentication Server Function (AUSF), a Network Slice Selection Function (NSSF), a Network Exposure Function (NEF), a Network Repository Function (NRF), the Policy Control Function (PCF), a Unified Data Management (UDM), and the Application Function (AF). This list of NFs is non-limiting.

In the Control Plane (CP), AMF is in charge of mobility management along with the possible handovers of a user. SMF is responsible for maintaining the existing session. AUSF and UDM are standardized to create and manage authentication keys to perform UE authentication and authorization. NSSF, NEF, NRF, PCF, and AF also belong to CP and are important in many control and management tasks, but they are out of scope in this article. In the User Plane (UP), UPF forwards the traffic between UEs and Data Network (DN). Furthermore, SMF instructs UPF to create packet detection and forwarding rules. To consume services provided by a Mobile Network Operator (MNO), UE can connect the air interface to the RAN (e.g., the gNB), then request NAS signaling processing at AMF and PDU session establishment. NFs in Service-Based Architecture (SBA) communicate one another over Service-Based Interface (SBI) using the Hypertext Transfer Protocol (HTTP) and the Transport Layer Security (TLS) for security connection, or through the reference points using transport and application layer-specific protocols.

An NF exposes and consumes services via reference points using the producer-consumer model. For instance, NAS signaling between UE and AMF is performed via N1. The N2 interface is the point-to-point communication between gNB and AMF for transferring of session management messages. The N3 interface between gNB and UPF is used for exchanging packets in UP, whereas N11 is used for AMF and SMF interactions. The N4 interface is employed by SMF for sending rules of packet detection and forwarding to UPF. Finally, the N6 interface connects UPF and DN, which is commonly the Internet.

Most of the time, an information producing NF in a Public Land Mobile Network (PLMN) offers mobile services for UEs connected to a 5G-NR and/or non-3GPP access network inside the Home Public Land Mobile Network (HPLMN), i.e., UE consumes services in the same local that the subscriber profile is configured. However, an NF may also offer services for UEs outside HPLMN, i.e., when they are roaming. Roaming in 5G allows a UE to employ mobile services outside its coverage area or in a Visited Public Land Mobile Network (VPLMN). The term “home network” as used herein is equivalent to HPLMN, and the term “visited network” as used herein is an alternative to any external network (VPLMN) that provides mobile services to a UE outside its home network.

For example, a roaming 5GS architecture can be illustrated using the non-limiting examples of a Local Breakout (LBO) scenarios and a Home Routed (HR) scenario, which can be applied to untrusted, trusted and wireline non-3GPP access networks.

In the LBO roaming case, the user data traffic, e.g., resulting from PDU session establishment initiated by UE, is routed from the visited network to the DN. The UE connects to the gNB in the visited network and consumes NF services, such as AMF for CP and SMF for UP functions from this network. Only the authentication procedure and the subscription handling are performed in the home network.

In HR roaming, the signaling data related to the authentication procedure and the visited network data traffic resulting from PDU session establishment are routed to DN from the home network. HR roaming provides additional control to MNO, such as accounting and billing information. This approach can increase the complexity and delay of the communications.

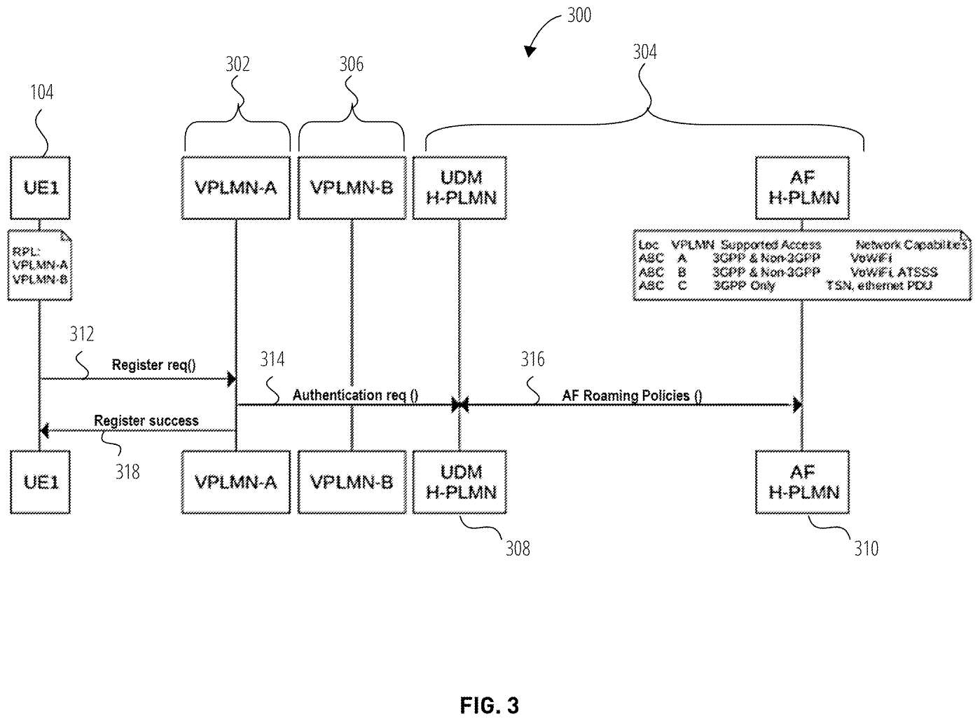

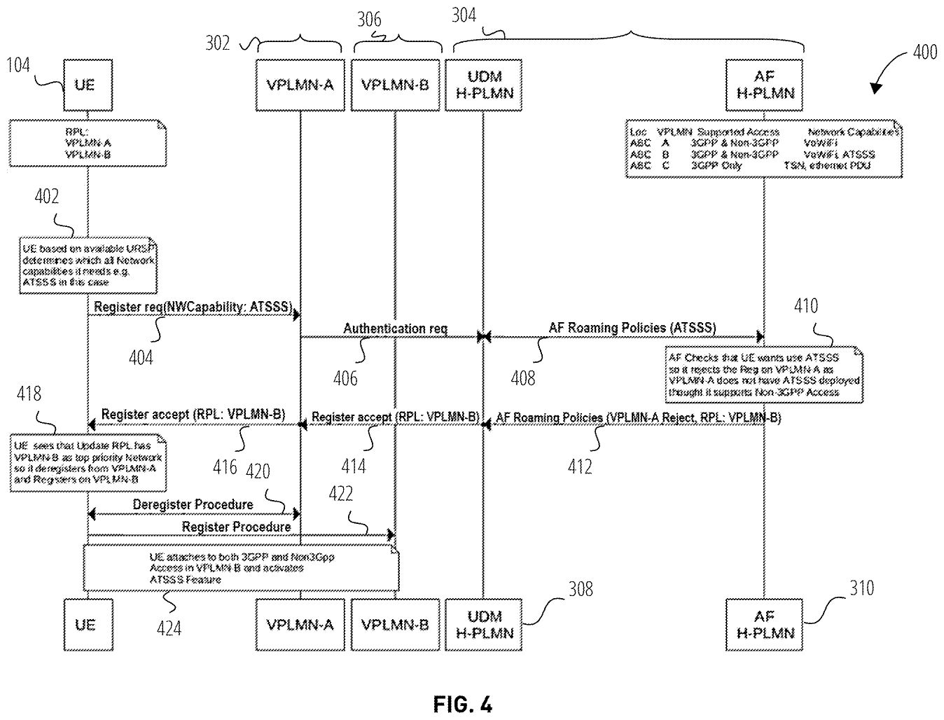

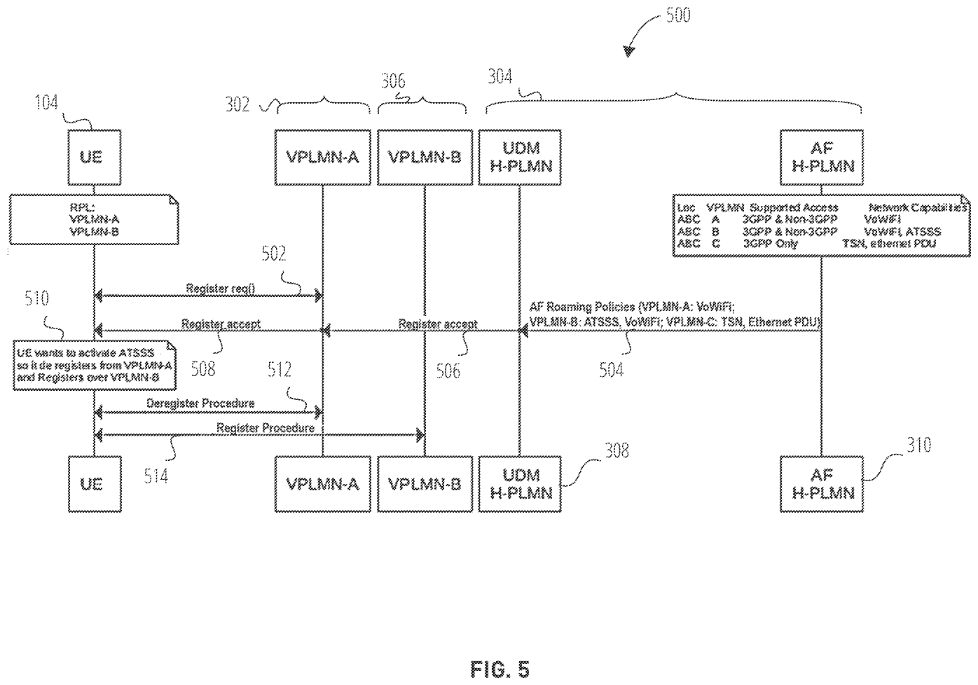

FIG. 3 illustrates an example of a call flow 300 for an SoR process that lacks network-capability awareness. The UE 104 includes an RPL in which VPLMN-A and VPLMN-B are listed as preferred visited networks, with VPLMN-A having priority over VPLMN-B. The UE 104 is at location ABC, meaning that it is with the coverage areas of VPLMN-A, VPLMN-B, and VPLMN-C. Based on the RPL, the UE 104 secks to attach to the highest priority visited network that is available. Both VPLMN-A and VPLMN-B are available, but VPLMN-A 302 has priority over VPLMN-B 306, resulting in the UE 104 sending a registration request to VPLMN-A 302, at step 312. In response, the VPLMN-A 302 then sends an authentication request to the Unified Data Management (UDM) 308 of the HPLMN 304, at step 314. At step 316, the UDM 308 interacts with the AF 310 of the HPLMN 304 to communicate the roaming policies. At step 318, the VPLMN-A 302 signal a successful registration. For call flow 300, the registration process is performed without awareness of the network capability. Thus, when the UE 104 requires ATSSS (or another network capability), the UE 104 only discovers later that VPLMN-A 302 lacks the ATSSS capability. A preferable solution would be to modify the RPL to prioritize the visited network having the desired capabilities, as is the case for the call flows in FIG. 4 and FIG. 5.

FIG. 4 illustrates an example of a first call flow 400 for an SoR process with network-capability awareness. The UE 104 includes an RPL that lists VPLMN-A and VPLMN-B as preferred visited networks, with VPLMN-A having priority over VPLMN-B. Based on the RPL, the UE 104 seeks to attach to VPLMN-A 302, which is the highest priority visited network that is available.

At step 402, the UE 104 determines which network capabilities are desired, based on an available UE Route Selection Policy (URSP). In the non-limiting example that is illustrated in FIG. 4, the desired network capability is ATSSS.

At step 404, the UE 104 sends a registration request to VPLMN-A 302, and the registration request includes the desired network capability (e.g., ATSSS).

At step 406, the VPLMN-A 302 sends an authentication request to the UDM 308 of the HPLMN 304.

At step 408, the UDM 308 interacts with the AF 310 of the HPLMN 304 to communicate the roaming policies. As part of these communications, the UDM 308 signals to the AF 310 the desired network capabilities.

At step 410, the AF 310 checks which network capabilities are desired by the UE 104 (i.e., ATSSS in the illustrated, non-limiting example). Based on this, the AF rejects the registration when the registration request is for a visited network that lacks the desired network capabilities. Here, the AF 310 checks that VPLMN-A 302 lacks the ATSSS capability, even though VPLMN-A 302 does support non-3GPP access. Therefore, AF 310 rejects the registration on VPLMN-A 302. The AF 310 also determines that VPLMN-B 306 does support the desired network capabilities (i.e., ATSSS in this example).

At step 412, the AF 310 signals with the roaming policies that the registration to VPLMN-A 302 is rejected and signals that VPLMN-B 306 should be promoted in the RPL, and thereby the UE 104 should register with VPLMN-B 306 instead of VPLMN-A 302.

At step 414, the UDM 308 signals in the registration acceptance that VPLMN-B 306 should be promoted in the RPL to have a higher priority than VPLMN-A 302.

At step 416, the VPLMN-A 302 relays the message in the registration acceptance that VPLMN-B 306 should be promoted in the RPL to have a higher priority than VPLMN-A 302.

At step 418, the UE 104 observes in the received registration acceptance the message that VPLMN-B 306 should be promoted in the RPL to have a higher priority than VPLMN-A 302. That is, the update RPL message has VPLMN-B 306 as the top priority network. Consequently, the UE 104 determines to deregister from VPLMN-As 302 and register instead with VPLMN-B 306.

At step 420, the UE 104 performs a procedure to deregister from VPLMN-As 302,

At step 422, the UE 104 performs a procedure to register instead with VPLMN-B 306.

At step 424, the UE 104 uses the desired network capabilities, which in this example is the ATSSS network capabilities. That is, the UE VPLMN-A 302 signal a successful registration. For the call flow 300, the registration process is performed without awareness of the network capability. Thus, when the UE 104 attaches to both 3GPP and non-3GPP access in the VPLMN-B 306 and activates the ATSSS feature.

FIG. 5 illustrates an example of a first call flow 500 for an SoR process with network capability awareness. The UE 104 includes an RPL that lists VPLMN-A and VPLMN-B as preferred visited networks, with VPLMN-A having priority over VPLMN-B. Based on the RPL, the UE 104 seeks to attach to VPLMN-A 302, which is the highest priority visited network that is available. at

At step 502, the UE 104 sends a registration request to VPLMN-A 302, and the registration request does not include any desired network capability.

At step 504, the UDM 308 interacts with the AF 310 of the HPLMN 304 to communicate the roaming policies. As part of these communications, the AF 310 signals to the UDM 308 the network capabilities of the respective visited networks at location ABC. In this non-limiting example, the network capability of VPLMN-A 302 is voice over WiFi (VoWiFi). The network capabilities of VPLMN-B 306 are VoWiFi and ATSSS, and the network capabilities of VPLMN-C are time sensitive network (TSN) and ethernet PDU. Step 504 can occur before or after step 502.

At step 506, the UDM 308 of the HPLMN 304 sends to the VPLMN-A 302 a registration acceptance, which includes the information regarding the network capabilities of the respective visited networks at location ABC.

At step 508, VPLMN-A 302 relays the registration acceptance to UE 104, including the information regarding the network capabilities of the respective visited networks at location ABC.

At step 510, the UE 104 stores the information regarding the network capabilities. Further, the UE 104 determines that a network capability is desired. In this non-limiting example, the UE 104 determines to activate the ATSSS feature. Based on the UE 104 stored network capabilities for the visited networks, the UE 104 reprioritizes the PRL with VPLMN-B 306 being prioritized over VPLMN-A 302 due to having the desired network capabilities. Accordingly, the UE 104 determines to deregister from VPLMN-As 302 and register instead with VPLMN-B 306.

At step 512, the UE 104 performs a procedure to deregister from VPLMN-As 302,

At step 514, the UE 104 performs a procedure to register instead with VPLMN-B 306.

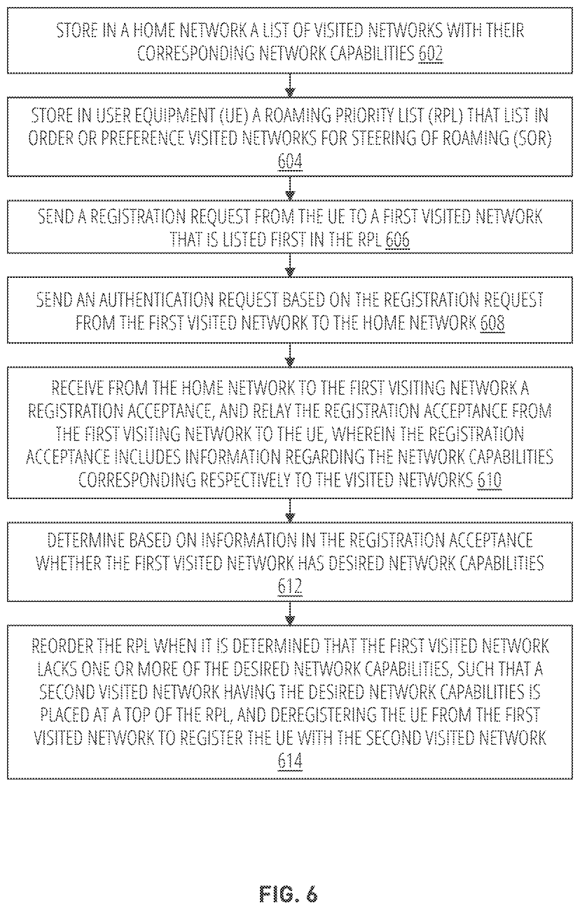

FIG. 6 illustrates an example routine for SoR with network capability awareness. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, at block 602, the method includes storing in a home network a list of visited networks with their corresponding network capabilities. For example, the AF 310 in FIG. 4 and FIG. 5 includes a list indicating that, at location ABC, VPLMN-A 302 has the network capability of VoWiFi; VPLMN-B 306 has the network capabilities of VoWiFi and ATSSS; and VPLMN-C has the network capabilities of TSN and ethernet PDU.

According to some examples, at block 604, the method includes storing in user equipment (UE) a roaming partners list (RPL) that list in order or preference visited networks for steering of roaming (SOR). For example, the UE 104 in FIG. 4 and FIG. 5 includes an RPL listing in order of preference VPLMN-A 302 and VPLMN-B 306.

According to some examples, at block 606, the method includes sending a registration request from the UE to a first visited network that is listed first in the RPL. For example, in FIG. 4, the UE 104 sends the registration request to VPLMN-A 302 in step 404. Further, in FIG. 5, the UE 104 sends the registration request to VPLMN-A 302 in step 502. In certain non-limiting examples, the registration request can also include an indication of the desired network capabilities. For example, in FIG. 4, the UE 104 includes a message that the ATSSS feature is a desired network capability in the registration request sent to VPLMN-A 302 in step 404.

According to some examples, the method includes, at block 608, sending an authentication request based on the registration request from the first visited network to the home network. For example, in FIG. 4, VPLMN-A 302 sends the authentication request to UDM 308 in step 406. In contrast, in FIG. 5, VPLMN-A 302 does not send an authentication request to UDM 308.

According to some examples, at block 610, the method includes receiving from the home network to the first visiting network a registration acceptance, and relay the registration acceptance from the first visiting network to the UE, wherein the registration acceptance includes information regarding the network capabilities corresponding respectively to the visited networks.

For example, in FIG. 4, VPLMN-A 302 receives from the UDM 308 an acceptance of the registration at step 414, and VPLMN-A 302 then relays the acceptance of the registration top the UE 104 at step 416. The acceptance of the registration includes information regarding the network capabilities because the instruction to promote VPLMN-B 306 to the first position in the RPL is based on VPLMN-B 306 having the desired network capabilities.

Further, in FIG. 5, VPLMN-A 302 receives from the UDM 308 an acceptance of the registration at step 506, and VPLMN-A 302 then relays the acceptance of the registration top the UE 104 at step 508. The acceptance of the registration includes information regarding the network capabilities because it includes the information from the AF roaming policies indicating which network capabilities respectively correspond to which visited networks.

According to some examples, at block 612, the method includes determining based on information in the registration acceptance whether the first visited network has desired network capabilities. For example, in FIG. 4, at step 418, the UE 104 sees the update to the RPL in which VPLMN-B 306 is the top priority, prompting the UE 104 to deregister from VPLMN-A 302 and register with VPLMN-B 306. Further, in FIG. 5, at step 510, the UE 104 determines a desired network capability (i.e., ATSSS), and, on the basis of this desired network capability being supported by VPLMN-B 306 and not supported by VPLMN-A 302, the UE 104 decides to deregister from VPLMN-A 302 and register with VPLMN-B 306.

According to some examples, at block 614, the method includes reordering the RPL when it is determined that the first visited network lacks one or more of the desired network capabilities, such that a second visited network having the desired network capabilities is placed at a top of the RPL, and deregistering the UE from the first visited network to register the UE with the second visited network. In both FIG. 4 and FIG. 5, the UE 104 updates the RPL based on the information regarding the network capabilities that is received with the registration acceptance. In FIG. 4, the UE 104 deregisters from VPLMN-A 302 at step 420, and the UE 104 registers with VPLMN-B 306 at step 422. In FIG. 5, the UE 104 deregisters from VPLMN-A 302 at step 512, and the UE 104 registers with VPLMN-B 306 at step 514.

In FIG. 4 and FIG. 5, the decision regarding whether the RPL should be reordered is performed at different locations. In FIG. 4, the decision regarding whether the RPL should be reordered is performed by the AF 310 at step 410 based on the desired network capabilities that are communicated to the AF 310 in step 408. The information stored in AF 310 regarding which network capabilities correspond respectively to which of the visited networks is compared against the desired network capabilities communicated in step 408 to determine which of the visited networks supports the desired network capabilities. When the visited network corresponding to the registration and authentication requests does not support the desired network capabilities, the AF 310 finds one or more other visited at the location of the UE 104 that do support the desired network capabilities. Then, an instruction to promote the one or more other visited network to the top of the RPL is sent at step 412.

In FIG. 5, the decision regarding whether the RPL should be reordered is performed by the UE 104 at step 510, after the UE 104 determines which network capabilities are desired. The UE 104 makes the decision to reorder the RPL by comparing the desired network capabilities to the network capabilities corresponding respectively to the visited networks that were previously communicated from the AF 310 to the UE 104 in steps 504, 506, and 508. When the first visited network in the RPL (e.g., the registered visited network) does not support the desired network capabilities, the UE 104 finds one or more other visited at the location of the UE 104 that do support the desired network capabilities, and the UE 104 promotes the one or more other visited network to the top of the RPL is sent at step 510.

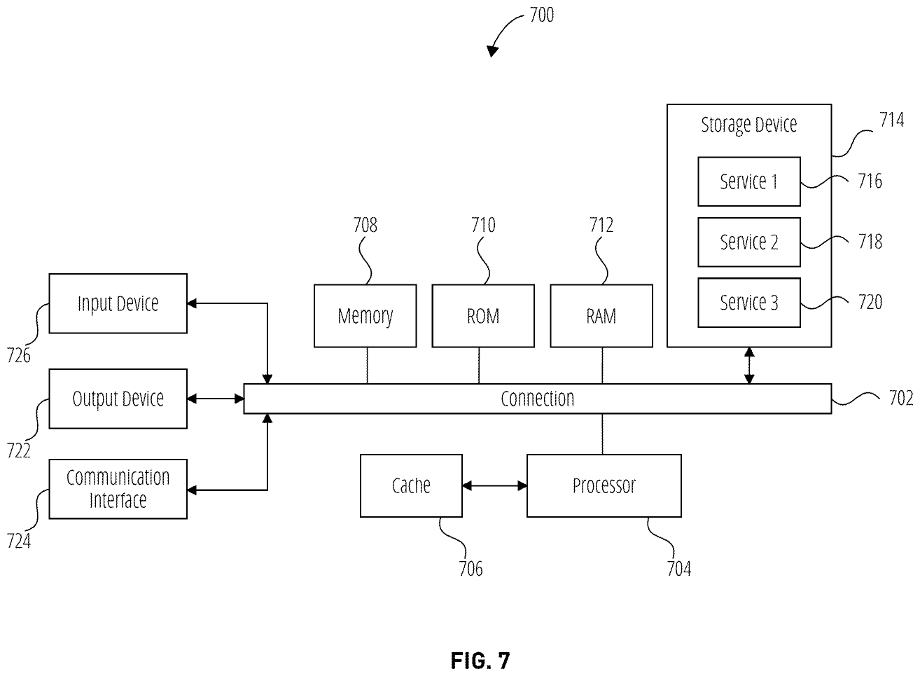

FIG. 7 shows an example of computing system 700, which can be for example any computing device making up UE 104, RAN 102, gNB 202, AF 310, and UDM 308, or any component thereof in which the components of the system are in communication with each other using connection 702. Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) 704 and connection 702 that couples various system components including system memory 708, read-only memory (ROM) 710, and random access memory (RAM) 712 to processor 604. Computing system 700 can include a cache of high-speed memory 706 connected directly with, in close proximity to, or integrated as part of processor 704.

Processor 704 can include any general-purpose processor and a hardware service or software service, such as services 716, 718, and 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method for bringing network capability awareness to steering of roaming, the method comprising:
providing, in a home network, a first list of visited networks, wherein the first list includes visited networks, and the first list associates the visited networks with corresponding network capabilities of the respective visited networks;
providing, in user equipment (UE), a roaming partners list (RPL) that includes a plurality of visited networks arranged in order of priority with a first visited network having priority over other visited networks in the plurality of visited networks;
receiving, at the first visited network, a registration request from the UE, wherein registration request is a request to register the UE with the first visited network; and
determining whether to register the UE with the first visited network based on whether the first list indicates that the first visited network is associated with a first network capability, wherein the first network capability is a network capability that is requested by the UE.

2. The method of claim 1, further comprising:
sending, from the UE to the first visited network, the registration request that includes an indication that the first network capability is being requested by the UE;
receiving, at the home network, an authentication request from the first visited network, wherein the authentication request indicates that the first network capability is being requested;
comparing, at the home network, the first network capability to the network capabilities in the first list; and
determining, based on the comparison, whether the first visited network supports the first network capability, and generating thereby a determination result.

3. The method of claim 2, wherein determining whether the first visited network supports the first network capability is based on comparing the first network capability to the network capabilities in the first list to determine whether the first network capability matches one or more network capabilities in the first list that are associated with the visited network.

4. The method of claim 2, wherein, when the determination result is that the first visited network supports the first network capability, the method further comprises:
sending, to the first visited network, an acceptance of the registration request; and
registering the UE with the first visited network.

5. The method of claim 2, wherein, when the determination result is that the first visited network does not support the first network capability, the method further comprises:
sending, to the first visited network, an instruction for the UE to reorder the plurality of visited network in the RPL such that one or more other visited network that are determined by the comparison to the first list to support the first network capability are prioritized ahead of the first visited network; and
registering the UE with a second visited network that is in a highest priority in the reordered RPL.

6. The method of claim 1, further comprising:
receiving, from the first visited network to the UE, network-capability information indicating which of the visited networks in the first list are associated with which network capabilities;
determining that the UE wants a first network capability; and
comparing, at the UE, the first network capability to the received network-capability information to determine whether the first visited network supports the first network capability, and generating thereby a determination result.

7. The method of claim 6, when the determination result is that the first visited network supports the first network capability, the method further comprises:
registering the UE with the first visited network.

8. The method of claim 6, wherein, when the determination result is that the first visited network does not support the first network capability, the method further comprises:
reordering the RPL such that an other visited network that supports the first network capability is moved to a top of the RPL and is thereby prioritized ahead of the first visited network; and
registering the UE with the other visited network.

9. The method of claim 1, wherein the first network capability is selected from the group consisting of a time sensitive network (TSN) feature, an access traffic steering, switching and splitting (ATSSS) feature, an ATSSS lower layer (ATSSS-LL) feature, a voice over WiFi (VoWiFi) feature, an ethernet protocol data unit (PDU) feature, a multi-path transmission control protocol (MPTCP), an MPTCP Proxy feature, a fine timing measurement (FTM) feature, and a non-regulatory location services feature.

10. The method of claim 1, further comprising:
registering the UE with the first visited network;
after registering that the UE with the first visited network, signaling, at the UE, that based on the first list the first visited network does not support the first network capability;
reordering the RPL such that an other visited network that supports the first network capability is moved to a top of the RPL and is thereby prioritized ahead of the first visited network;
deregistering the UE with the first visited network; and
registering the UE with the other visited network.

11. A computing apparatus comprising:
a processor; and
a memory storing instructions that, when executed by the processor, configure the apparatus to:
provide, in a home network, a first list of visited networks, wherein the first list includes visited networks, and the first list associates the visited networks with corresponding network capabilities of the respective visited networks;
provide, in user equipment (UE), a roaming partners list (RPL) that includes a plurality of visited networks arranged in order of priority with a first visited network having priority over other visited networks in the plurality of visited networks;
receive, at the first visited network, a registration request from the UE, wherein registration request is a request to register the UE with the first visited network; and
determine whether to register the UE with the first visited network based on whether the first list indicates that the first visited network is associated with a first network capability, wherein the first network capability is a network capability that is requested by the UE.

12. The computing apparatus of claim 11, wherein, when executed by the processor, the stored instructions further configure the apparatus to:
send, from the UE to the first visited network, the registration request that includes an indication that the first network capability is being requested by the UE;
receive, at the home network, an authentication request from the first visited network, wherein the authentication request indicates that the first network capability is being requested;
compare, at the home network, the first network capability to the network capabilities in the first list; and
determine, based on the comparison, whether the first visited network supports the first network capability, and generating thereby a determination result.

13. The computing apparatus of claim 12, wherein the determining whether the first visited network supports the first network capability is based on comparing the first network capability to the network capabilities in the first list to determine whether the first network capability matches one or more network capabilities in the first list that are associated with the visited network.

14. The computing apparatus of claim 12, wherein, when executed by the processor, the stored instructions further configure the apparatus to:
conditionally send, to the first visited network, an acceptance of the registration request, based on a condition that the determination result is the first visited network supports the first network capability; and
register the UE with the first visited network.

15. The computing apparatus of claim 12, wherein, when executed by the processor, the stored instructions further configure the apparatus to:
conditionally send, to the first visited network, an instruction based on a condition that the determination result is the first visited network supports the first network capability, wherein the instruction is for the UE to reorder the plurality of visited network in the RPL such that one or more other visited network that are determined by the comparison to the first list to support the first network capability are prioritized ahead of the first visited network; and
register the UE with a second visited network that is in a highest priority in the reordered RPL.

16. The computing apparatus of claim 11, wherein, when executed by the processor, the stored instructions further configure the apparatus to:
receive, from the first visited network to the UE, network-capability information indicating which of the visited networks in the first list are associated with which network capabilities;
determine that the UE wants a first network capability; and
compare, at the UE, the first network capability to the received network-capability information to determine whether the first visited network supports the first network capability, and generating thereby a determination result.

17. The computing apparatus of claim 16, wherein, when executed by the processor, the stored instructions further configure the apparatus to:
conditionally send, to the first visited network, an acceptance of the registration request, based on a condition that the determination result is the first visited network supports the first network capability; and
register the UE with the first visited network.

18. The computing apparatus of claim 16, wherein, when executed by the processor, the stored instructions further configure the apparatus to:
conditionally reorder the RPL, based on a condition that the determination result is that the first visited network does not support the first network capability, wherein the RPL is reordered such that an other visited network that supports the first network capability is moved to a top of the RPL and is thereby prioritized ahead of the first visited network; and
registering the UE with the other visited network.

19. The computing apparatus of claim 11, wherein the first network capability is selected from the group consisting of a time sensitive network (TSN) feature, an access traffic steering, switching and splitting (ATSSS) feature, an ATSSS lower layer (ATSSS-LL) feature, a voice over WiFi (VoWiFi) feature, an ethernet protocol data unit (PDU) feature, a multi-path transmission control protocol (MPTCP), an MPTCP Proxy feature, a fine timing measurement (FTM) feature, and a non-regulatory location services feature.

20. The computing apparatus of claim 11, wherein, when executed by the processor, the stored instructions further configure the apparatus to:
register the UE with the first visited network;
after registering the UE with the first visited network, signal, based on the first list, that the first visited network does not support the first network capability, wherein the signaling occurs at the UE;
reorder the RPL such that an other visited network that supports the first network capability is moved to a top of the RPL and is thereby prioritized ahead of the first visited network;
deregister the UE with the first visited network; and
register the UE with the other visited network.
